(19) United States
(12) Patent Application Publication
(10) Pub. No.: US 2026/0111799 A1
(43) Pub. Date: Apr. 23, 2026

(54) ACCURACY AND RELIABILITY OF ARTIFICIAL INTELLIGENCE-PREDICTED ATTRIBUTES FOR MEDIA ITEMS

(71) Applicant: Google LLC, Mountain View, CA (US)

(72) Inventors: Yilin Wang, Sunnyvale, CA (US); Yaohong Wu, San Jose, CA (US); Neil Aylon Charles Birkbeck, Santa Cruz, CA (US); Balineedu Chowdary Adsumilli, Sunnyvale, CA (US)

(21) Appl. No.: 19/363,519

(22) Filed: Oct. 20, 2025

Related U.S. Application Data
(60) Provisional application No. 63/709,735, filed on Oct. 21, 2024.

(51) Int. Cl. G06N 20/00

(52) U.S. Cl. CPC G06N 20/00

(57) ABSTRACT

Methods and systems for improving accuracy and reliability of artificial intelligence (AI)-predicted attributes for media items are provided. A first and second variant of a media item are obtained, and their respective first and second quality metrics are identified using an AI model. Based on these quality metrics, a first quality loss value, representing a deviation of one or both metrics from a reference quality metric, and a second quality loss value, representing a difference between the first and second quality metrics, are determined. These loss values are then provided for retraining the AI model to predict improved quality metrics for additional media items.

### RELATED APPLICATIONS

This non-provisional application claims priority to U.S. Provisional Patent Application No. 63/709,735, filed Oct. 21, 2024, entitled “A GENERAL FRAMEWORK TO IMPROVE RELIABILITY OF NO-REFERENCE BASED VIDEO QUALITY METRICS,” which is incorporated herein by reference in its entirety for all purposes.

### TECHNICAL FIELD

Aspects and implementations of the present disclosure relate to improving accuracy and reliability of artificial intelligence-predicted attributes for media items.

### BACKGROUND

Content sharing platforms provide media items, such as videos, audio, images, etc., to client devices over a network. These platforms often evaluate attributes of media items to optimize user experience, ensure efficient content delivery, improve transcoding and compression, enhance content discovery and recommendation, and so forth. In some cases, a platform may determine the quality of a media item using one or more artificial intelligence (AI) models trained to quality metrics for media items.

### SUMMARY

The summary below is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining a first variant and a second variant of a media item. The method further includes identifying a first quality metric representing a first quality of the first variant and a second quality metric representing a second quality of the second variant. The first quality metric and the second quality metric are obtained using an artificial intelligence (AI) model. The method further includes determining, based on the first quality metric and the second quality metric, a first quality loss value representing a deviation of one or more of the first quality metric or the second quality metric from a reference quality metric associated with the media item, and a second quality loss value representing a difference between the first quality metric and the second quality metric. The method further includes providing the determined first quality loss value and the determined second quality loss value for retraining the AI model to predict improved quality metrics for additional media items.

In some implementations, determining the first quality loss value includes providing the one or more of the first quality metric or the second quality metric and the reference quality metric as an input to a mean squared error operation. The method further includes obtaining one or more outputs of the mean squared error operation, the one or more outputs comprising the first quality loss value.

In some implementations, determining the second quality loss value includes providing the first quality metric and the second quality metric as an input to a hinge loss operation. The method further includes obtaining one or more outputs of the hinge loss operation, the one or more outputs comprising the second quality loss value.

In some implementations, the method further includes, prior to providing the determined first quality loss value and the determined second quality providing the media item for retraining the AI model, providing the media item as an input to the AI model. The method further includes obtaining one or more outputs of the AI model, the one or more outputs including a quality metric predicted for the media item. The method further includes designating the quality metric predicted for the media item as the reference quality metric associated with the media item.

In some implementations, providing the determined first quality loss value and the determined second quality loss value for retraining the AI model includes calculating a total training loss value associated with the AI model based on the determined first quality loss value and the calculated second quality loss value. The method further includes modifying one or more parameters associated with the AI model based on the determined total training loss value.

In some implementations, modifying the one or more parameters associated with the AI model based on the calculated total training loss value includes performing one or more backpropagation operations using the total training loss value to obtain a gradient of total loss with respect to each of the one or more parameters associated with the AI model. The method further includes updating at least one of the one or more parameters associated with the AI model based on the obtained gradient of total loss to obtain an updated AI model.

In some implementations, the method further includes providing one or more additional variants of an additional media item as an input to the updated AI model. The method further includes obtaining one or more outputs of the updated AI model, the one or more outputs including predicted quality metrics for the one or more additional variants. The method further includes determining an updated total training loss value based on the predicted quality metrics for the one or more additional variants.

In some implementations, the method further includes determining whether the improved quality metrics predicted for the additional media items by the AI model satisfy one or more quality criteria. The method further includes, responsive to determining that the improved quality metrics satisfy the one or more quality criteria, updating a model pipeline associated with a content sharing platform to include the AI model.

In some implementations, the method further includes identifying the media item at a data store associated with a content sharing platform. The method further includes generating the first variant and the second variant based on the identified media item, wherein the first variant has a different quality than the second variant.

In some implementations, generating the first variant and the second variant based on the identified media item includes providing the media item as an input to a first compression operation and as an input to a second compression operation. The method further includes obtaining one or more outputs of the first compression operation and the second compression operation. The one or more outputs include the first variant and the second variant.

In some implementations, generating the first variant and the second variant based on the identified media item includes providing the media item as an input to a first enhancement operation and as an input to a second enhancement operation, wherein the first enhancement operation and the second enhancement operation comprise at least one of a sharpness adjustment operation, a brightness adjustment operation, a contrast adjustment operation, a color balance adjustment operation, a noise reduction operation, a stabilization operation, a scaling operation, a resizing operation, or an edge enhancement operation. The method further includes obtaining one or more outputs of the first enhancement operation and the second enhancement operation. The one or more outputs include the first variant and the second variant.

In some implementations, obtaining the first quality metric and the second quality metric includes providing the first variant and the second variant as an input to the AI model, obtaining one or more outputs of the AI model, and extracting, from the one or more outputs, the first quality metric and the second quality metric.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example media attribute engine, in accordance with implementations of the present disclosure.

FIG. 3 is a block diagram of an example method for improving accuracy and reliability of artificial intelligence (AI)-predicted attributes for media items, in accordance with implementations of the present disclosure.

FIG. 4 is a block diagram of an example of obtaining quality loss values for improving accuracy and reliability of AI-predicted attributes for media items, in accordance with implementations of the present disclosure.

FIG. 5 is a block diagram of an example predictive system, in accordance with implementations of the present disclosure.

FIG. 6 is a block diagram of an example method for retraining an AI model based on quality loss values, in accordance with implementations of the present disclosure.

FIG. 7 is a block diagram illustrating an exemplary computer system, in accordance with implementations of the present disclosure.

### DETAILED DESCRIPTION OF THE DRAWINGS

Aspects of the present disclosure generally relate to improving accuracy and reliability of artificial intelligence (AI)-predicted attributes for media items. Platforms (e.g., a content sharing platform) can enable users to share media items (e.g., video items, audio items, etc.) with other users. Such platforms handle a vast and ever-growing volume of media items, which are provided by a significant number of users (e.g., millions) daily. Due to the scale and diversity of such user-provided media items, platforms operate in a dynamic environment and prioritize maintaining a high quality experience for end users, which involves processing, storing, and delivering media items efficiently and effectively across a wide array of client devices and network conditions. This involves complex operations such as transcoding media into different formats and bitrates, applying compression to save bandwidth and storage, and selecting the optimal version of a media item to serve to a user.

The effective and efficient curation and distribution of content to a large audience depends on the quality (e.g., perceptual quality, technical quality, etc.) of such content. For example, within a content delivery pipeline, a platform may use or otherwise consider the quality of a media item (e.g., bitrate, resolution, presence of compression artifacts, etc.) to select a transcoding technique or transcoding settings for the media item, for adaptive bitrate streaming optimization (e.g., that adjust video resolution based on network conditions), to perform content ranking and recommendation, to perform automated content enhancement (e.g., sharpening or color correction, etc.), and so forth. In some instances, an inaccurate quality metric or other such attribute can lead a platform to select an inefficient compression scheme that wastes storage and bandwidth by encoding at a needlessly high bitrate or degrading the media item unnecessarily. In other instances, a platform may apply detrimental transformations to content of a media item based on flawed quality feedback. Accordingly, the accurate and reliable assessment of quality and other such attributes impacts the efficient and effective operation of the media processing and delivery infrastructure of a content sharing platform.

Conventionally, platforms assess media quality using reference-based metrics, which involves comparing a processed media item (e.g., which has been compressed, enhanced, resized, scaled, etc.) to its original (e.g., pristine) version to quantify degradation caused by (or related to) the processing. However, in the context of user-provided media items, a pristine, original version of a media item is frequently unavailable. Accordingly, some platforms implement no-reference quality assessment techniques, which sometimes involve using artificial intelligence (AI) models trained to predict quality metrics or other attributes associated with media items. Such AI models (referred to as media item attribute AI models) are typically trained on large datasets that have been manually rated (e.g., by humans) to generate ground truth quality metrics.

Conventional media item attribute AI models are trained to predict absolute quality metrics for individual media items and are not trained to identify quality relationships between different versions of the same media item, which can lead such AI models to be unreliable and inaccurate. For example, when a media item undergoes a series of enhancements, such as incremental sharpening, the predicted quality metric should increase to a point and then decrease as the image becomes over sharpened. However, conventionally trained models that are fed media items reflecting such enhancements produce inconsistent quality metrics that fluctuate unpredictably, failing to capture the enhancement progression. In another example, when a high-quality media item is encoded at progressively lower bitrates, such quality score should decrease monotonically. However, such conventionally trained models are found to assign a higher quality metric to a more compressed, lower-bitrate version than to a less compressed version, as such models are predicting the absolute quality of the media items without considering the relative quality across multiple media items.

Unreliable and inaccurate quality metrics (and other such attributes) obtained using conventionally trained AI models can impact the overall performance and user experience associated with a content sharing platform. A platform relying on unreliable and inaccurate quality metrics may unnecessarily initiate computationally expensive operations that, in some instances, are actively harmful. For example, a platform relying on a low quality metric for a high-quality 4K media item may initiate an unnecessary transcoding process, which consumes significant processing cycles and memory space to create a redundant or lower-quality variant. In another example, a platform relying on a low quality metric for a high quality media item may apply a series of unnecessary enhancement filters (e.g., sharpening or color correction), each of which consumes processing power on operations that yield no (or minor) perceptible improvement.

Embodiments of the present disclosure provide techniques for retraining AI models to improve the reliability and consistency of media quality assessment. A platform can obtain two or more variants of a media item that are each associated with a different quality metric. In an illustrative example, the platform may obtain a first variant by applying a first degradation operation to a media item (e.g., to introduce a first level of noise to content of the media item) and may obtain a second variant by applying a second degradation operation to the media item (e.g., to introduce a second level of noise to the content of the media item). In another illustrative example, the platform may obtain a first variant by compressing the media item using a first codec and/or at a first bitrate and may obtain a second variant by compressing the media item using a second codec and/or at a second bitrate.

Upon obtaining the two or more variants of the media item, the platform can obtain quality metrics associated with the original media item and each respective variant. For example, the platform can provide the original media item and each variant as an input to an AI model trained to predict a quality metric (or other attributes) associated with given media items. The platform can obtain one or more outputs of the AI model, which can include a quality metric for the original media item and each variant. The quality metric associated with the original media item can represent a reference quality metric for the unmodified version of the media item.

The platform can determine an absolute quality loss and a relative quality loss associated with the AI model based on the quality metrics obtained for the original media item and the variants. An absolute quality loss can reflect a deviation or difference of the quality metric for one or more variants of the media item from the reference quality metric obtained for the original media item. The relative quality loss can reflect a difference between the quality metrics for each respective media item variant. In some embodiments, the platform can calculate a total quality loss associated with the AI model based on the absolute quality loss and the relative quality loss associated with the AI model. Further details regarding the total quality loss are provided below.

In some embodiments, the platform (or another system associated with the platform) can provide the total quality loss determined for the AI model for retraining of the AI model. For example, the platform can perform one or more back propagation operations to the AI model using the total quality loss to obtain a gradient of loss for each parameter of the AI model. Based on the obtained gradient of loss, the platform can update one or more parameters of the AI model and can obtain a quality metric for another media item using the updated AI model. Upon determining that the updated AI model satisfies one or more retraining criteria in view of the obtained quality metric (e.g., a determined accuracy of the quality metric exceeds a threshold value, etc.), the platform can update a model pipeline to include the updated AI model. Upon determining that the retraining criteria are not satisfied, the platform can obtain quality loss values based on an additional media item and/or variants obtained for the additional media item and can update the AI model parameters based on the obtained quality loss values. The platform can continue to iteratively update the AI model parameters based on quality loss values obtained for media item variants, as described herein, until the retraining criteria are satisfied.

Implementations of the present disclosure address the above and other deficiencies of conventional systems by introducing a retraining framework that enforces both absolute quality evaluation and relative quality evaluation of given media items. As described herein, the platform determines, based on a quality metric for a reference media item and a quality metric for at least one variant of the reference media item, an absolute quality loss associated with an AI model. By retraining the AI model using the determined absolute quality loss, embodiments of the present disclosure anchor the model's predictions to a reference quality metric, therefore preserving the foundational accuracy of the model. The platform further determines, based on quality metrics for each variant of the media item, a relative quality loss associated with the AI model. By retraining the AI model using the determined relative quality loss, embodiments of the present disclosure penalize the AI model for producing counter-intuitive or non-monotonic quality metrics, such as assigning a higher quality metric to a more heavily compressed variant. The platform can update parameters of the AI model using backpropagation techniques based on the determined absolute quality loss and relative quality loss, therefore correcting the AI model's ability to predict reliable and consistent quality metrics.

As the AI model is retrained to produce more reliable and consistent quality metrics, the platform, relying on such metrics, can perform appropriate operations with respect to media items using appropriate operation settings, which can improve the overall performance and user experience associated with the platform. For example, based on a low quality metric obtained for a media item using the retrained AI model, the platform may apply a series of enhancement filters (e.g., sharpening or color correction) using settings that accurately reflect the targeted quality improvement associated with the media item, which may significantly improve the perceptual quality of the media item. In another example, the platform may determine, based on a high quality metric obtained for a media item using the retrained AI model, that the media item can be distributed without the performance of computationally expensive operations (e.g., transcoding operations, enhancement operations, etc.). The computing resources (e.g., processing cycles, memory space, network bandwidth, power, etc.) that would have been consumed by such computationally expensive operations can be available to other processes of the system, which improves an overall efficiency and decreases an overall latency of the system.

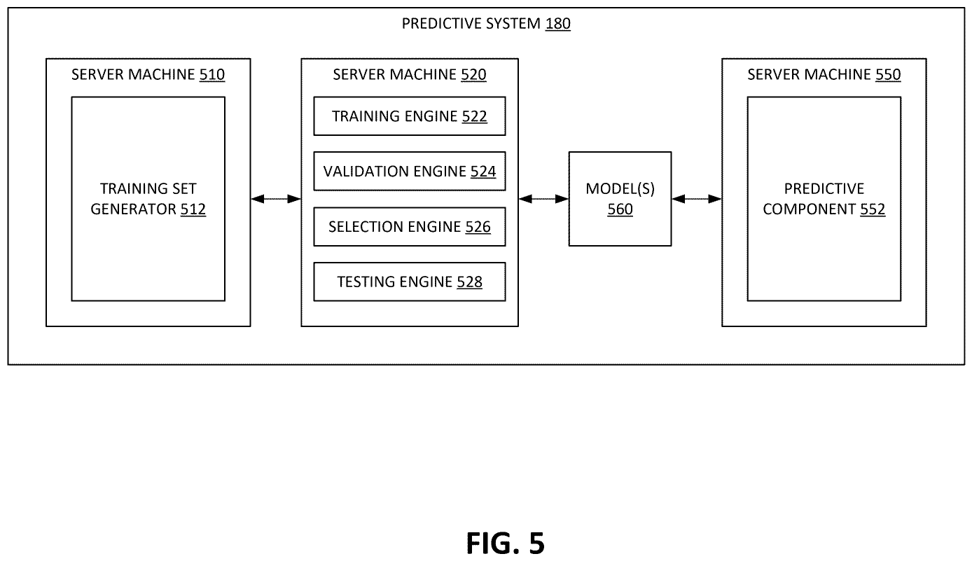

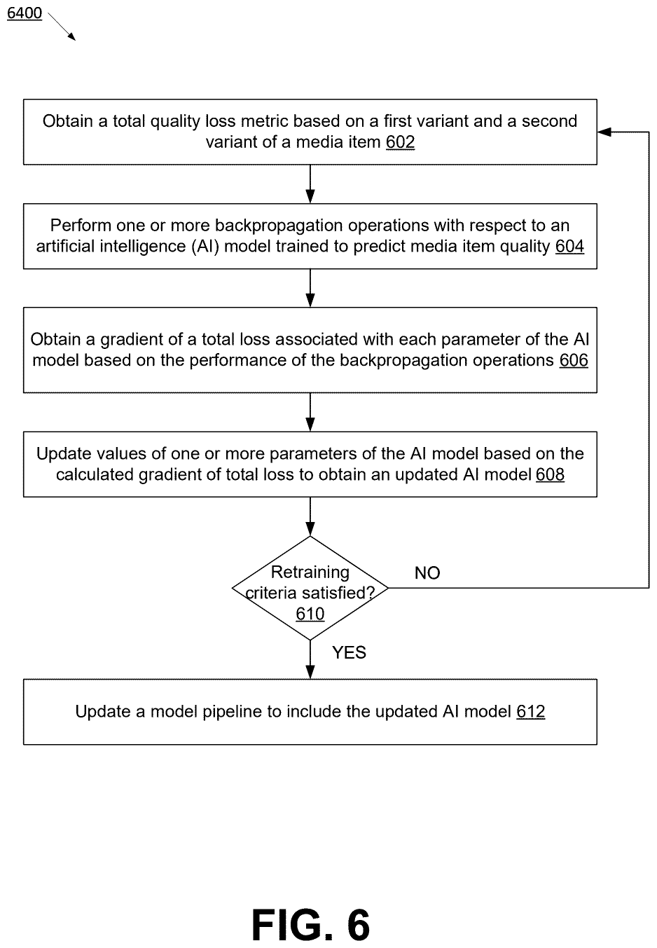

It should be noted that although some embodiments and examples of the present disclosure are directed to quality metrics associated with media items of a content sharing platform, such embodiments and examples can be applied to other metrics associated with media items of other platforms or systems. For example, embodiments and examples of the present disclosure can be applied to content relevance metrics, user experience metrics, media item playback performance metrics, and so forth. It should also be noted that although some embodiments and examples of the present disclosure are directed to retraining an AI model (e.g., that may have been previously trained using a prior data set), such embodiments and examples may be applied to training an AI model (e.g., which has not been previously trained). For example, embodiments and examples of the present disclosure can be applied to collect training data associated with training a model artifact to predict a quality metric or other such metric associated with media items of a platform. Such training data can be used with or in place of ground truth data associated with the media items. Further details regarding training a model artifact in accordance with techniques of the present disclosure are provided below with respect to FIGS. 5-6.

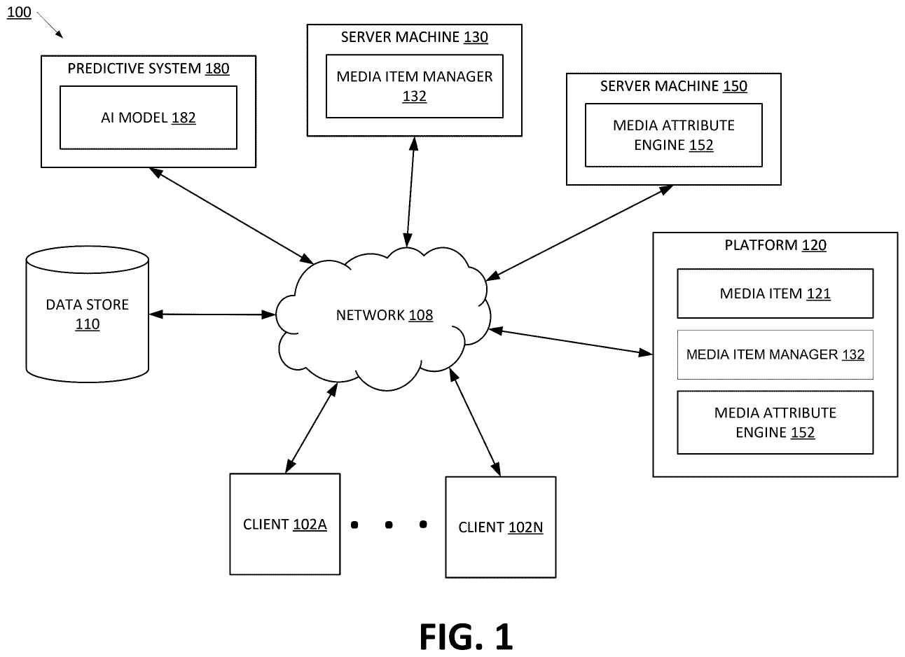

FIG. 1 illustrates an example system architecture 100, in accordance with implementations of the present disclosure. example system architecture 100, in accordance with implementations of the present disclosure. The system architecture 100 (also referred to as “system” herein) includes client devices 102A-N, a data store 110, a platform 120, and/or one or more server machines (e.g., server machine 130, server machine 150, etc.) each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N (collectively and individually referred to as client device(s) 102 herein) can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, a media item 121 can be a short-form media item. A short-form media item refers to a media item 121 that has a duration that falls below a particular threshold duration (e.g., as defined by a developer or administrator of platform 120). In one example, a short-form media item can have a duration of 120 seconds or less. In another example, a short-form media item can have a duration of 60 seconds or less. In other or similar embodiments, a media item 121 can be a long-form media item. A long-form media item refers to a media item that has a longer duration than a short-form media item (e.g., several minutes, several hours, etc.). In some embodiments, a short-form media item may include visually or audibly rich or complex content for all or most of the media item duration, as a content creator has a smaller amount of time to capture the attention of users accessing the media item 121 and/or to convey a target message associated with the media item 121. In additional or similar embodiments, a long-form media item may also include visually or audibly rich or complex content, but such content may be distributed throughout the duration of the long-form media item, diluting the concentration of such content for the duration of the media item 121. As described above, data store 110 can store media items 121, which can include short-form media items and/or long-form media items, in some embodiments. In additional or alternative embodiments, data store 110 can store one or more long-form media items and can store an indication of one or more segments of the long-form media items that can be presented as short-form media items. It should be noted that although some embodiments of the present disclosure refer specifically to short-form media items, such embodiments can be applied to long-form media items, and vice versa. It should also be noted that embodiments of the present disclosure can additionally or alternatively be applied to live streamed media items (e.g., which may or may not be stored at data store 110).

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated with media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

Platform 120 can include a media item manager 132 that is configured to manage media items 121 and/or access to media items 121 of platform 120. As described above, users of platform 120 can provide media items 121 (e.g., long-form media items, short-form media items, etc.) to platform 120 for access by other users of platform 120. As described herein, a user that creates or otherwise provides a media item 121 for access by other users is referred to as a “creator.” A creator can include an individual user and/or an enterprise user that creates content for or otherwise provides a media item 121 to platform 120. A user that accesses a media item 121 is referred to as a “viewer,” in some instances. The user can provide (e.g., upload) the media item 121 to platform 120 via a user interface (UI) of a client device 102, in some embodiments. Upon providing the media item 121, media item manager 132 can store the media item 121 at data store 110 (e.g., at a media item corpus or repository of data store 110).

In some embodiments, media item manager 132 can store the media item 121 with data or metadata associated with the media item 121. Data or metadata associated with a media item 121 can include, but is not limited to, information pertaining to a duration of media item 121, information pertaining to one or more characteristics of media item 121 (e.g., a type of content of media item 121, a title or a caption associated with the media item, one or more hashtags associated with the media item 121, etc.), information pertaining to one or more characteristics of a device (or components of a device) that generated content of media item 121, information pertaining to a viewer engagement pertaining to the media item 121 (e.g., a number of viewers who have endorsed the media item 121, comments provided by viewers of the media item, etc.), information pertaining to audio of the media item 121 and/or associated with the media item 121, and so forth. In some embodiments, media item manager 132 can determine the data or metadata associated with the media item 121 (e.g., based on media item analysis processes performed for a media item received by platform 120). In other or similar embodiments, a user (e.g., a creator, a viewer, etc.) can provide the data or metadata for the media item 121 (e.g., via a UI of a client device 102). In an illustrative example, a creator of the media item 121 can provide a title, a caption, and/or one or more hashtags pertaining to the media item 121 with the media item 121 to platform 120. The creator can additionally or alternatively provide tags or labels associated with the media item 121, in some embodiments. Upon receiving the data or metadata from the creator (e.g., via network 104), media item manager 132 can store the data or metadata with media item 121 at data store 110.

As used herein, a hashtag refers to a metadata tag that is prefaced by the hash symbol (e.g., “#”). A hashtag can include a word or a phrase that is used to categorize content of the media item 121. As indicated above, in some embodiments, a creator or user associated with a media item 121 can provide platform 120 with one or more hashtags for the media item 121. In other or similar embodiments, media item manager 132 and/or another component of platform 120 or of another computing device of system 100 can derive or otherwise obtain a hashtag for media item 121. It should be noted that the term “hashtag” is used throughout the description for purposes of example and illustration only. Embodiments of the present disclosure can be applied to any type of metadata tag, regardless of whether such metadata tag is prefaced by the hash symbol.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

Media attribute engine 152 can determine one or more media attributes of a media item 121, which may be used for various purposes by platform 120. Media attributes can include, but are not limited to, quality metrics (e.g., indicating a perceptual or technical quality of a media item 121), relevance metrics (e.g., indicating a relevance of content of a media item 121 to a topic), user experience metrics (e.g., indicating or quantifying a user experience or predicted user experience associated with the media item 121), media item playback performance (e.g., indicating or quantifying a playback performance or predicted playback performance associated with the media item 121), and so forth. Example use cases associated with media attributes include, for example, encoding optimization (e.g., selecting a codec and/or encoding settings for media items 121), storage management (e.g., allocating storage tiers depending on quality and expected demand), transcoding (e.g., triggering encoding or re-encoding of media items 121 that fall below quality thresholds), content indexing and retrieval (e.g., structuring content or metadata in distributed databases to support low-latency search), recommendation engine training (e.g., feeding relevance metrics into recommender models for ranking), cache placement (e.g., prefetching and caching content that is predicted to be most relevant in a given geographic region or to particular groups of users), UI adaptation (e.g., dynamically adjusting layout, font size, captioning options, etc. to improve user experience and/or for accessibility), model feedback loops (e.g., using implicit engagement signals to retrain personalization models), client device-specific tuning (e.g., modifying UI or playback parameters depending on device constraints), adaptive bitrate control (e.g., switching streams of media items 121 in real-time or approximately real-time based on available bandwidth), load balancing (e.g., redirecting playback requests across multiple edge nodes of system 100 depending on congestion), error detection and recovery (e.g., automatically retrying streams or swapping protocols when errors are detected), telemetry-driven scaling (e.g., using playback metrics to trigger autoscaling of computing resources during peak demand), and so forth.

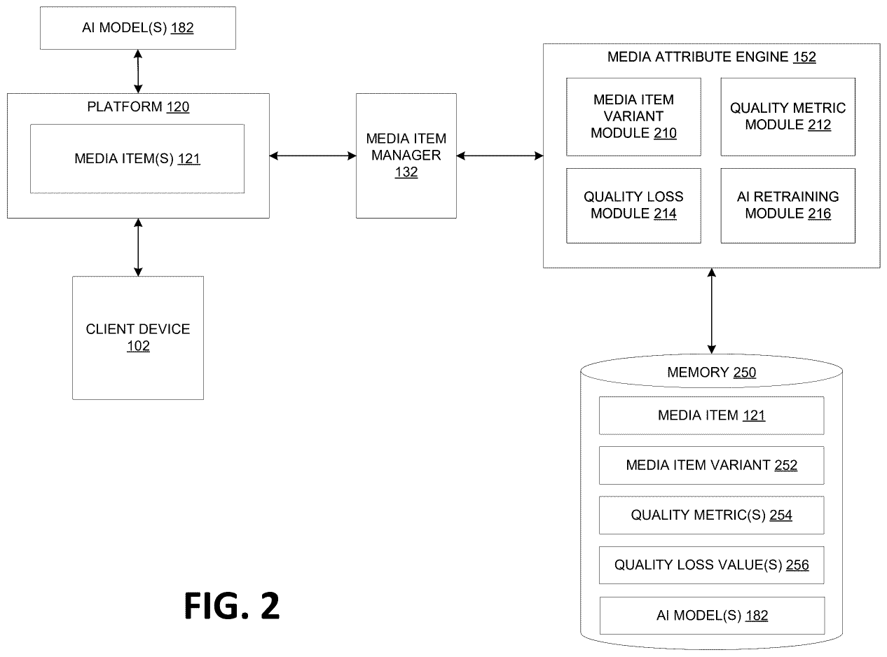

Media attribute engine 152 may determine or otherwise obtain media attribute(s) associated with a media item 121 using one or more AI models 182 of predictive system 180. In some embodiments, predictive system 180 can include one or more AI models 182 that are each trained to predict a respective media item attribute of a given media item 121. In other or similar embodiments, one or more AI models 182 of predictive system 180 may be trained to predict multiple media item attributes. As described herein, media attribute engine 152 can obtain training data that can be used to retrain AI model(s) 182 to improve the accuracy and reliability of media attribute predictions of AI model(s) 182). Further details regarding retraining AI model(s) 182 are provided below with respect to FIGS. 2-6.

In accordance with embodiments described herein, an AI model 182 can be trained to predict a quality metric associated with a given media item 121. Such AI model 182 can include, but is not limited to, a video quality assessment (VQA) model (e.g., a no-reference VQA model, a full-reference VQA model), a neural network (e.g., a convolutional neural network (CNN) based model, a recurrent neural network (RNN) or long short-term memory (LSTM) based model, a transformer-based model, etc.), a quality of experience (QoE) prediction model (e.g., a supervised machine learning model, a reinforcement model, a hybrid model, etc.), and so forth. It should be noted that although some embodiments and examples of the present disclosure refer to training and/or retraining an AI model for improved predictions of quality metrics associated with a media item 121, such embodiments can be applied to non-AI models that predict or otherwise obtain quality metrics associated with media items 121, such as mathematical and/or statistical models (e.g., regression models, exponential/logarithmic decay models, utility functions, etc.), network performance models (e.g., buffering probability models, startup delay models, Markov models, etc.), and so forth.

It should be noted that although FIG. 1 illustrates media attribute engine 152 as part of platform 120, in additional or alternative embodiments, media attribute engine 152 can reside on one or more server machines or systems that are remote from platform 120 (e.g., server machine 130, server machine 150). It should be noted that in some other implementations, the functions of server machines 150, predictive system 180 and/or platform 120 can be provided by a fewer number of machines. For example, in some implementations, components and/or modules of any of server machine 130, server machine 150, and/or predictive system 180 may be integrated into a single machine, while in other implementations components and/or modules of any of server machine 130, server machine 150, and/or predictive system 180 may be integrated into multiple machines. In addition, in some implementations, components and/or modules of any of server machine 130, server machine 150 and/or predictive system 180 may be integrated into platform 120.

In general, functions described in implementations as being performed by platform 120, server machines 130, 150 and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 illustrates an example media attribute engine 152, in accordance with implementations of the present disclosure. As described above, platform 120 can provide users (e.g., of client devices 102) with access to media items 121. Media items 121 can include long-form media items and/or short-form media items. In some embodiments, a user (e.g., a creator) can provide a media item 121 to platform 120 for access by other users (e.g., viewers) of platform 120. Media item manager 132 can identify media items 121 of interest and/or relevant to users (e.g., based on a user access history, a user search request, etc.) and can provide the users with access to the identified media items 121 via client devices 102.

As described herein, media attribute engine 152 can determine one or more media attributes of a media item 121. Media attributes can include, but are not limited to, quality metrics, relevance metrics, user experience metrics, media item playback performance metrics, and so forth. In some embodiments, media attribute engine 152 can obtain the media attributes of media item 121 based on one or more outputs of an AI model 182 trained to predict media attributes of given media items 121. Media attribute engine 152 can additionally or alternatively obtain training data for retraining AI model 182 for improved prediction of media attributes, as described herein.

As illustrated in FIG. 2, media attribute engine 152 can include a media item variant module 210, a quality metric module 212, a quality loss module 214, and/or an AI retraining module 216. Details regarding trend detection by media attribute engine 152 are provided herein with respect to FIGS. 2-4. In some embodiments, platform 120, media item manager 132, and/or media attribute 152 can be connected to memory 250 (e.g., via network 108, via a bus, etc.). Memory 250 can correspond to one or more regions of data store 110, in some embodiments. In other or similar embodiments, one or more portions of memory 250 can include or otherwise correspond to any memory of or connected to system 100.

It should be noted that some embodiments and examples of the present disclosure are directed to obtaining and retraining an AI model 182 for improved prediction of quality metrics 254. However, such embodiments and examples are not intended to be limiting and are provided for the purpose of example and illustration only. Embodiments and examples can be applied to AI models 182 that predict any type of media item metric, as described herein. It should also be noted that although embodiments and examples of the present disclosure describe media attribute engine 152 as obtaining the data for retraining the AI model(s) 182, any other component of system 100 can be configured to obtain the training data for retraining the AI model(s) 182. For example, one or more components of predictive system 180 (e.g., training set generator 512) can perform one or more operations associated with media attribute engine 152 to obtain the training data for retraining model(s) 182, as described herein.

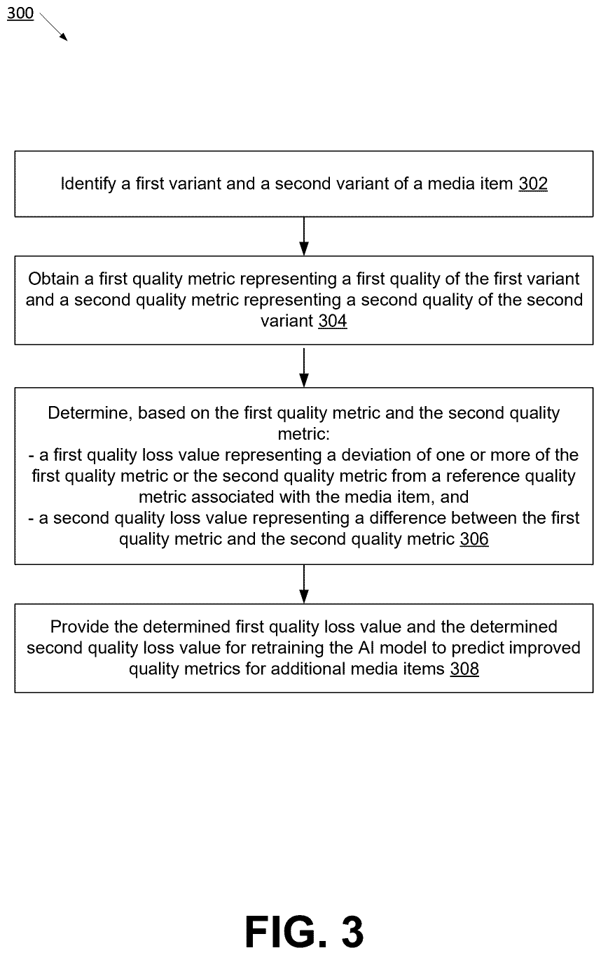

FIG. 3 is a block diagram of an example method 300 for improving accuracy and reliability of artificial intelligence (AI)-predicted attributes for media items, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by media attribute engine 152 and/or one or more components of predictive system 180 (e.g., training set generator 512).

At block 302, processing logic identifies a first variant and a second variant of a media item. In some embodiments, platform 120 can maintain a data store (e.g., a corpus) of media items 121 provided by users of platform 120. Such media items 121 can include video items, images, audio items, etc.). In some embodiments, media item variant module 210 of media attribute engine 152 can select a media item 121 of the data store for use in training or retraining AI model 182 for improved quality metric prediction. Media item variant module 210 may select the media item 121 based on a content category (e.g., gaming, sports, music, etc.), technical characteristics (e.g., a resolution, a codec associated with the media item, etc.), or a previously determined quality metric associated with the media item 121. In some embodiments, media item variant module 210 may select the media item 121 based on a training data selection protocol associated with platform 120 and/or based on an instruction received from a client device associated with a developer or operator of platform 120.

Upon selecting a media item 121 for use in training or retraining AI model 182, media item variant module 210 may obtain two or more variants 252 of the media item. A variant 252 of a media item 121 refers to a modified version of media item 121 that has different perceptual and/or technical characteristics of the original version of the media item 121. Media item variant module 210 may obtain a variant 252 of media item 121 by performing one or more transformation operations with respect to the media item 121, which alter the quality or characteristics of the media item 121. In an illustrative example, media item variant module 210 may provide media item 121 as an input to one or more compression operations, where each compression operation encodes the media item 121 at different codecs (e.g., AV1, VP9, H.264, etc.) and/or at different bitrates. Media item variant module 210 may obtain an output of the one or more compression operations, which include one or more variants 252 of media item 121 each encoded using a different codec and/or at different bitrates. A variant 252 encoded at a lower bitrate may be associated with a lower quality and/or have more compression artifacts than a variant 252 encoded at a higher bitrate. In another example, media item variant module 210 may provide media item 121 as an input to one or more enhancement operations that adjust a sharpness, brightness, contrast, color balance, etc. associated with given media items 121. Media item variant module 210 may obtain an output of the one or more enhancement operations, which include one or more variants of media item 121 each having different degrees of enhancement (e.g., different sharpness levels, different brightness levels, etc.). Other example transformations that can be applied to a media item 121 to obtain a variant includes resizing or scaling the media item 121 to different resolutions (e.g., 4K, 1080p, 720p, etc.), introducing noise, applying stabilization features, and so forth.

At block 304, processing logic obtains a first quality metric representing a first quality of the first variant and a second quality metric representing a second quality of the second variant. A quality metric 254 can include a numerical value or score that represents the perceptual quality or a technical quality of a media item 121 and/or a media item variant 252. A perceptual quality of a media item 121 (or variant 252) reflects how the media item 121 will be perceived by a viewer and may represent a clarity, sharpness, contrast, color fidelity, presence of compression artifacts, and so forth. A technical quality of a media item 121 (or variant 252) reflects characteristics that impact how a media item 121 is generated, stored, or delivered, and may represent a bitrate, resolution, frame rate, signal-to-noise ratio, an error rate, or other encoding or transmission characteristics.

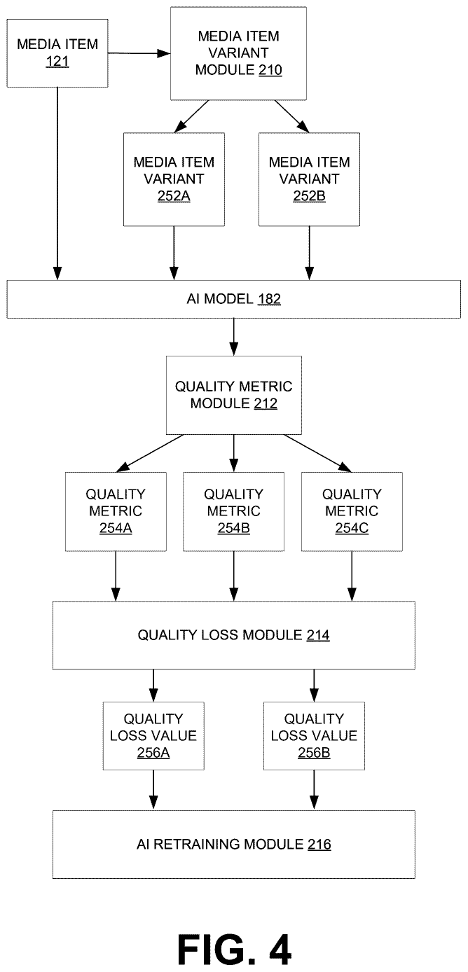

In some embodiments, the AI model 182 may have been previously trained to predict quality metrics associated with given media items 121. In such embodiments, quality metric module 212 may provide the media item variants 252 as an input to the AI model 182 and may obtain one or more outputs of the AI model 182, which can include quality metrics 254 associated with each media item variant 252. As illustrated by FIG. 4, quality metric module 212 may provide the original media item 121 as an input to the AI model 182 and obtain one or more outputs, which can include a quality metric 254 associated with the original media item 121.

In other or similar embodiments, quality metric module 212 may obtain the quality metrics 254 in accordance with other techniques. For example, quality metric module 212 may determine a quality metric 254 for the original media item (e.g., quality metric 254A) based on ground truth data provided by a user associated with platform 120. Example ground truth data can include, but is not limited to, subjective ratings (e.g., mean opinion scores) reflecting the perceived quality of the media item 121, pairwise comparison values associated with the media item 121 (e.g., an indication of a selection of two or more media items 121 based on which one looks or sounds better), categorical labels (e.g., user-assigned descriptors such as “blurry,” “sharp,” color accurate,” smooth playback,” etc.). In some embodiments, quality metric module 212 may provide the media item variants 252 (e.g., media item variant 252A, media item variant 252B, etc.) generated based on media item 121 for presentation to the user (e.g., via a client device 102 or another device) and the user may provide ground truth data pertaining to the variants 252. Quality metric module 212 may determine the quality metrics 254 for media item variant 252A and/or media item variant 252B (e.g., quality metric 254B, quality metric 254C, respectively) based on the user provided ground truth data, in some embodiments. It should be noted that quality metric module 212 may obtain the quality metrics 254 for the media item 121 and/or one or more variants 252 in accordance with other techniques. For example, quality metric module 212 may obtain quality metrics 254 based on one or more outputs of another AI model (e.g., other than AI model 182) associated with system 100 and/or another platform or system that is different from platform 120 and/or system 100. As described herein, the quality metric 254A obtained for the original media item 121 is referred to as a reference quality metric 254A.

At block 306, processing logic determines, based on the first quality metric and the second quality metric, a first quality loss value representing a deviation of one or more of the first quality metric or the second quality metric from a reference quality metric associated with the media item. Processing logic further determines, based on the first quality metric and the second quality metric, a second quality loss representing a difference between the first quality metric and the second quality metric. The first quality loss value 256A can represent an absolute quality loss associated with the AI model 182, in some embodiments. An absolute quality loss refers to a deviation or difference of the quality metric 254 for one or more variants of media item 121 from the reference quality metric 254A associated with media item 121. In an illustrative example, quality loss module 214 may determine the absolute quality loss associated with AI model 182 by calculating or otherwise determining a difference between the reference quality metric 254A and the quality metric 254B associated with media item variant 252A and/or the quality metric 254C associated with media item variant 252B. In some embodiments, quality loss module 214 may identify the media item variant 252 having a higher quality metric value (e.g., among each obtained media item variant) and may calculate the difference between the reference quality metric 254A and the quality metric for such media item variant 252. For example, upon determining that the value of quality metric 254B associated with media item variant 252A is higher than the value of quality metric 254C associated with media item variant 252B, quality loss module 214 may calculate or otherwise determine a difference between reference quality metric 254A and quality metric 254B.

In some embodiments, quality loss module 214 may calculate or otherwise determine the absolute quality loss associated with AI model 182 by providing the reference quality metric 254A and quality metric 254B as an input to a mean squared error operation, which calculates or otherwise determines the average squared difference between estimated values (e.g., quality metric 254B) and a true value (e.g., reference quality metric 254A). Quality loss module 214 can obtain one or more outputs of the mean squared error operation and can extract the absolute quality loss from the one or more outputs.

The second quality loss value 256B represents a relative quality loss associated with AI model 182. A relative quality loss reflects a difference between quality metrics across media item variants 252. In some embodiments, quality loss module 214 may determine the relative quality loss associated with AI model 182 by calculating or otherwise determining a difference between the quality metric 254B associated with media item variant 252A and the quality metric 254C associated with media item variant 252B.

In some embodiments, quality loss module 214 can obtain the relative quality loss based on one or more outputs of a hinge loss operation. A hinge loss operation is configured to calculate a penalty value when metrics predicted by an AI model (e.g., AI model 182) violate a known quality order. Quality loss module 214 can provide the second quality metric 254B and the third quality metric 254C as an input to the hinge loss operation and obtain one or more outputs of the hinge loss operation, which indicate a magnitude of error between the quality metrics 254.

At block 308, processing logic provides the determined first quality loss value and the determined second quality loss value for retraining the AI model to predict improved quality metrics for additional media items. In some embodiments, quality loss module 214 may calculate or otherwise determine a total loss associated with AI model 182 based on the absolute quality loss (e.g., quality loss value 256A) and relative quality loss (e.g., quality loss value 256B) associated with AI model 182. The total loss can represent a weighted sum of the absolute loss and the relative loss determined for AI model 182, in some embodiments. Equation 1 below provides an example equation for calculating the total loss based on the absolute loss and relative loss:

$$L = wq * Lq + wp * Lr \qquad Equation 1$$

where L represents the total loss associated with AI model 182, Lq represents the absolute quality loss associated with AI model 182, Lr represents the relative quality loss associated with AI model 182, wq represents a predefined weight associated with the absolute quality loss, and wp represents a predefined weight associated with the relative quality loss. Weights wq and wr may be provided or otherwise defined by a developer or operator of platform 120, in some embodiments. In other or similar embodiments, weights wq and wr may be determined based on empirical testing or experimentation. Weights wq and wr can be static values or may be dynamically adjusted during a training process to fine-tune the behavior of AI model 182A, as described herein. It should be noted that Equation 1 above is provided for purposes of example and illustration only and is not intended to be limiting. A total loss associated with AI model 182 can be determined in accordance with other equations or techniques, in accordance with embodiments described herein.

In some embodiments, AI retraining module 216 may use the quality loss values 256 (e.g., the absolute quality loss, the relative quality loss, the total loss, etc.) obtained for AI model 182 to retrain AI model 182. Further details regarding retraining the AI model 182 are provided herein with respect to FIGS. 5-6 below.

FIG. 5 is a block diagram of an example predictive system 180, in accordance with implementations of the present disclosure. As illustrated in FIG. 5, predictive system 180 can include a training set generator 512 (e.g., residing at server machine 510), a training engine 512, a validation engine 524, a selection 526, and/or a testing engine 528 (e.g., each residing at server machine 520), and/or a predictive component 552 (e.g., residing at server machine 550). Training set generator 512 may be capable of generating training data (e.g., a set of training inputs and a set of target outputs) to train one or more AI model 560. In some embodiments, AI model 560 can include AI model 182 that predicts media attributes (e.g., quality metrics) associated with media items 121 of platform 120.

Training set generator 512 can generate a training dataset to train AI model 560 by obtaining a set of labeled media items 121 each associated with a quality metric 254. In some embodiments, training set generator 512 can identify media items 121 for inclusion in the training dataset (referred to as training media items herein) from one or more media item data stores, which can include a publicly available data store or a privately available data store (e.g., maintained by or otherwise associated with platform 120). The training media items can have a wide variety of characteristics (e.g., genre, motion, texture complexity, etc.) and distortion types (e.g., blurring, noise, frame drops, various degrees of resolution or bitrate degradation, etc.). In some embodiments, the quality metric 254 assigned to each training media item can include a mean opinion score derived from formal subjective experiments where viewers (e.g., human viewers) rate perceptual quality. The mean opinion score may serve as a ground truth label for the model's supervised learning process. In some embodiments, the training data items can reflect a broad spectrum of possible real-world media quality scenarios, from high definition, high-bitrate sources to highly compressed user-generated content.

In some embodiments, training set generator 512 can generate an input-output mapping based on the obtained training media items and the obtained quality metrics associated with such training media items. In an illustrative example, an input of the input-output mapping can be based on the obtained training videos and the output of the input-output mapping can include the quality metrics 254. Upon generating the input-output mapping, training set generator 512 can provide the input-output mapping to training engine 522 for training AI model 560.

Training engine 522 can train an AI model 560 using the training data from training set generator 512. The AI model 560 can refer to the model artifact that is created by the training engine 522 using the training data that includes training inputs and/or corresponding target outputs (correct answers for respective training inputs). The training engine 522 can find patterns in the training data that map the training input to the target output (the answer to be predicted), and provide the AI model 560 that captures these patterns. The AI model 560 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. In some embodiments, AI model 560 can include, but is not limited to, a video quality assessment (VQA) model (e.g., a no-reference VQA model, a full-reference VQA model), a neural network (e.g., a convolutional neural network (CNN) based model, a recurrent neural network (RNN) or long short-term memory (LSTM) based model, a transformer-based model, etc.), a quality of experience (QoE) prediction model (e.g., a supervised machine learning model, a reinforcement model, a hybrid model, etc.), and so forth.

Validation engine 524 may be capable of validating a trained machine learning model 182 using a corresponding set of features of a validation set from training set generator 512. The validation engine 524 may determine an accuracy of each of the trained machine AI 560 based on the corresponding sets of features of the validation set. The validation engine 524 may discard a trained AI model 560 that has an accuracy that does not meet a threshold accuracy. In some embodiments, the selection engine 526 may be capable of selecting a trained machine learning model 182 that has an accuracy that meets a threshold accuracy. In some embodiments, the selection engine 526 may be capable of selecting the trained AI model 560 that has the highest accuracy of the trained AI models 560.

The testing engine 528 may be capable of testing a trained AI model 560 using a corresponding set of features of a testing set from training set generator 512. For example, a first trained machine learning model 182 that was trained using a first set of features of the training set may be tested using the first set of features of the testing set. The testing engine 528 may determine a trained machine learning model 182 that has the highest accuracy of all of the trained machine learning models based on the testing sets.

As described above, predictive component 552 of server 550 may be configured to feed data as input to model 182 and obtain one or more outputs. In some embodiments, predictive component 522 can include or be associated with media item manager 132 and/or media attribute engine 152. In other or similar embodiments, predictive component 522 can include or be associated with another process or engine of system 100. For example, predictive component 522 can be associated with an encoding engine of system 100, a media item enhancement engine of system 100, and so forth. Predictive component 552 can provide media items 121 as an input to AI model 560 and can obtain one or more outputs including a predicted quality metric 254. Media item manager 132, media attribute engine 152, and/or other processes or engines of system 100 can use the quality metric 254 obtained based on the one or more outputs for use in the performance of any type of operation described above (e.g., determining optimal encoding settings or codecs for the media item 121, determining optimal enhancement operations to be performed with respect to the media item 121, etc.).

As described above, AI retraining module 216 of media attribute engine 152 can perform one or more operations associated with retraining an AI model (e.g., AI model 560, AI model 182, etc.) for improved prediction of quality metrics 254 associated with given media items 121. Details regarding retraining AI model 560, 182 are provided below with respect to FIG. 6. In some embodiments, AI retraining module 216 can interface with or otherwise be associated with one or more components of predictive system 180. For example, AI retraining module 216 may interface with training set generator 510 and/or training engine 522.

FIG. 6 is a block diagram of an example method 600 for retraining an AI model based quality loss values, in accordance with implementations of the present disclosure. Method 600 can be performed by processing logic that can include hardware (circuitry, dedicated logic, etc.), software (e.g., instructions run on a processing device), or a combination thereof. In one implementation, some or all the operations of method 600 can be performed by one or more components of system 100 of FIG. 1. In some embodiments, some or all of the operations of method 600 can be performed by AI retraining module 216 of media attribute engine 152 and/or by predictive system 180.

At block 602, processing logic obtains a total quality loss metric based on a first variant and a second variant of a media item. In some embodiments, AI retraining model 216 can obtain the total quality loss metric based on an absolute quality loss and a relative quality loss determined for a media item 121, as described above with respect to FIG. 3. At block 604, processing logic performs one or more backpropagation operations with respect to an AI model trained to predict media item quality. At block 606, processing logic obtains a gradient of a total loss associated with each parameter of the AI model based on the performance of the backpropagation operation(s). Generally, backpropagation refers to computing how the error of an AI model changes with respect to its internal parameters (e.g., weights and biases) and using that information to update those parameters). Performing a backpropagation operation can involve applying a chain of derivatives function to determine how each parameter contributed to the error.

In some embodiments, AI retraining model 216 can provide the total quality loss metric obtained in accordance with block 602 as an input to the backpropagation operation, which can initiate a series of computations to determine a gradient of loss for each parameter of the AI model. A gradient is a multi-dimensional vector that points in the direction of the steepest ascent of a loss function and indicates how a small change in the parameter's value would affect the total loss. A large positive gradient for a particular weight signifies that increasing this weight will significantly increase the total loss, while a large negative gradient indicates that increasing the weight would decrease the loss. In accordance with the backpropagation operation, AI retraining model 216 can obtain the gradient of total loss for each parameter of AI model 182 based on the total quality loss metric.

At block 608, processing logic updates values of one or more parameters of the AI model based on the calculated gradient of total loss to obtain an updated AI model. Based on the calculated gradient of total loss determined for each parameter of AI model 182, AI retraining model 182 can provide the calculated gradient of total loss as an input to an optimization operation, which adjusts each parameter in the opposite direction of its corresponding gradient. The magnitude of this adjustment may be defined by a learning rate included in a retraining protocol associated with AI model 182 (e.g., provided by a developer or operator of system 100). An example optimization operation can include a stochastic gradient descent (SGD) operation or other such type of operation. By subtracting a fraction of the gradient from the current parameter value, the model is updated to a state where it would produce a lower total loss for the same input. The updated AI model can reflect the adjusted parameters, which are adjusted in accordance with the magnitude defined by the retraining protocol.

At block 610, processing logic determines whether one or more retraining criteria are satisfied based on the updated AI model. In some embodiments, AI retraining module 216 can obtain updated quality loss metrics 256 based on quality metrics 254 associated with the media item 121 and variants 252 associated with the media item 121, as described above. For example, media attribute engine 152 can obtain an updated absolute quality loss and an updated relative quality loss associated with a media item 121 and its variants 252 and can calculate or otherwise obtain an updated total quality loss metric based on the updated absolute quality loss and the updated relative quality loss, as described herein. Upon determining that the updated total quality loss metric meets or falls below a threshold total quality loss, AI retraining module 216 can determine that the one or more retraining criteria are satisfied. Upon determining that the updated total quality loss metric exceeds the threshold total quality loss, AI retraining module 216 can determine that the one or more retraining criteria are not satisfied.

The retraining criteria can include additional or alternative retraining criteria or thresholds, in some embodiments. For example, a retraining criterion can include the detection of the convergence of total loss by the AI model 182. In some embodiments, AI retraining module 216 can monitor a total loss value over a series of training iterations or epochs (e.g., a full pass through the entire training dataset). The retraining criterion may be satisfied when the loss value plateaus, meaning it no longer decreases significantly over a sustained period. In another example, a retraining criterion may be based on a fixed number of training iterations or a computational budget. Upon determining that a threshold number of training iterations (e.g., returns to block 602 from block 610) have been performed and/or a threshold amount of computational resources have been consumed during the training iterations, AI retraining module 216 can determine that the one or more retraining criteria are satisfied.

Responsive to a determination that the retraining criteria are not satisfied, method 600 returns to block 602. In some embodiments, AI retraining module 216 may obtain a total quality loss metric associated with another media item 121 and variant(s) 252 obtained for the other media item 121 and may update the parameters of AI model 182 based on the other media item 121, as described above. In other or similar embodiments, AI retraining module 216 may further modify the parameters of AI model 182 based on the gradient of loss determined for each parameter (e.g., by increasing the magnitude of adjustment), in accordance with block 606.

Responsive to a determination that the retraining criteria are satisfied, method 600 proceeds to block 612. At block 612, processing logic updates a model pipeline to include the updated AI model. In some embodiments, AI retraining module 216 can update a model pipeline associated with platform 120 to include the updated AI model. By including the updated AI model in the model pipeline, media attribute engine 152 and/or another component of system 100 can provide incoming media items 121 as an input to the updated AI model and can obtain one or more quality metrics 254 associated with the incoming media items 121 based on output(s) of the updated AI model.

As described above, in addition to retraining an already trained AI model, embodiments of the present disclosure can be applied to generate a training dataset for a new model artifact (e.g., which has not been previously trained). Media attribute engine 152 can generate variants 252 for a set of training media items, as described above, and can obtain quality metrics 254 associated with such training media items and quality variants 252. Rather than obtaining the quality metrics 254 based on output(s) of AI model 182, media attribute engine 152 can obtain the quality metrics 254 from a non-AI baseline model and/or based on human annotated labels for the media items and variants 252, as described above. Media attribute engine 152 can obtain absolute and relative loss values for the training media items and variants 252, as described above. Training set generator 510 can generate a training data set for the model artifact by generating a mapping between the training media item and its corresponding absolute and relative loss values. Training engine 522 can apply a total loss function to combine the absolute and relative loss values associated with a training media item, which trains the model to predict accurate and relational quality metrics, as described herein.

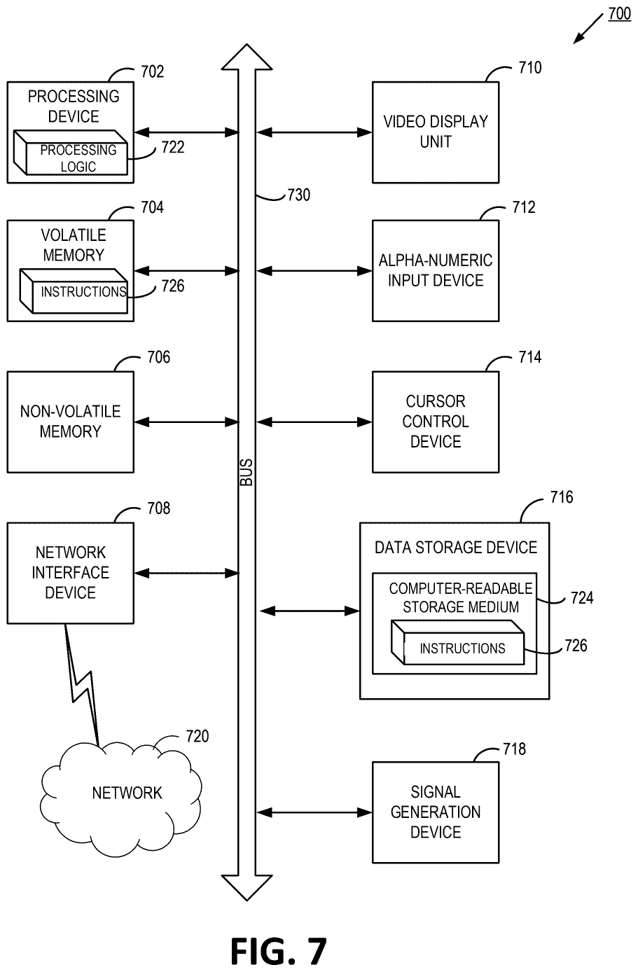

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, and the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining a first variant and a second variant of a media item;
identifying a first quality metric representing a first quality of the first variant and a second quality metric representing a second quality of the second variant, wherein the first quality metric and the second quality metric are obtained using an artificial intelligence (AI) model;
determining, based on the first quality metric and the second quality metric:
a first quality loss value representing a deviation of one or more of the first quality metric or the second quality metric from a reference quality metric associated with the media item, and
a second quality loss value representing a difference between the first quality metric and the second quality metric; and
providing the determined first quality loss value and the determined second quality loss value for retraining the AI model to predict improved quality metrics for additional media items.

2. The method of claim 1, wherein determining the first quality loss value comprises:
providing the one or more of the first quality metric or the second quality metric and the reference quality metric as an input to a mean squared error operation; and
obtaining one or more outputs of the mean squared error operation, the one or more outputs comprising the first quality loss value.

3. The method of claim 1, wherein determining the second quality loss value comprises:
providing the first quality metric and the second quality metric as an input to a hinge loss operation; and
obtaining one or more outputs of the hinge loss operation, the one or more outputs comprising the second quality loss value.

4. The method of claim 1, further comprising:
prior to providing the determined first quality loss value and the determined second quality loss value for retraining the AI model, providing the media item as an input to the AI model;
obtaining one or more outputs of the AI model, the one or more outputs comprising a quality metric predicted for the media item; and
designating the quality metric predicted for the media item as the reference quality metric associated with the media item.

5. The method of claim 1, wherein providing the determined first quality loss value and the determined second quality loss value for retraining the AI model comprises:
calculating a total training loss value associated with the AI model based on the determined first quality loss value and the determined second quality loss value; and
modifying one or more parameters associated with the AI model based on the calculated total training loss value.

6. The method of claim 5, wherein modifying the one or more parameters associated with the AI model based on the calculated total training loss value comprises:
performing one or more backpropagation operations using the total training loss value to obtain a gradient of total loss with respect to each of the one or more parameters associated with the AI model; and
updating at least one of the one or more parameters associated with the AI model based on the obtained gradient of total loss to obtain an updated AI model.

7. The method of claim 6, further comprising:
providing one or more additional variants of an additional media item as an input to the updated AI model;
obtaining one or more outputs of the updated AI model, the one or more outputs comprising predicted quality metrics for the one or more additional variants; and
determining an updated total training loss value based on the predicted quality metrics for the one or more additional variants.

8. The method of claim 1, further comprising:
determining whether the improved quality metrics predicted for the additional media items by the AI model satisfy one or more quality criteria; and
responsive to determining that the improved quality metrics satisfy the one or more quality criteria, updating a model pipeline associated with a content sharing platform to include the AI model.

9. The method of claim 1, further comprising:
identifying the media item at a data store associated with a content sharing platform; and
generating the first variant and the second variant based on the identified media item, wherein the first variant has a different quality than the second variant.

10. The method of claim 9, wherein generating the first variant and the second variant based on the identified media item comprises:
providing the media item as an input to a first compression operation and as an input to a second compression operation; and
obtaining one or more outputs of the first compression operation and the second compression operation, wherein the one or more outputs comprise the first variant and the second variant.

11. The method of claim 9, wherein generating the first variant and the second variant based on the identified media item comprises:
providing the media item as an input to a first enhancement operation and as an input to a second enhancement operation, wherein the first enhancement operation and the second enhancement operation comprise at least one of a sharpness adjustment operation, a brightness adjustment operation, a contrast adjustment operation, a color balance adjustment operation, a noise reduction operation, a stabilization operation, a scaling operation, a resizing operation, or an edge enhancement operation; and
obtaining one or more outputs of the first enhancement operation and the second enhancement operation, wherein the one or more outputs comprise the first variant and the second variant.

12. The method of claim 1, wherein obtaining the first quality metric and the second quality metric comprises:
providing the first variant and the second variant as an input to the AI model;
obtaining one or more outputs of the AI model; and
extracting, from the one or more outputs, the first quality metric and the second quality metric.

13. A system comprising:
a memory; and
a set of one or more processing devices, the set of one or more processing devices to perform operations comprising:
obtaining a first variant and a second variant of a media item;
identifying a first quality metric representing a first quality of the first variant and a second quality metric representing a second quality of the second variant, wherein the first quality metric and the second quality metric are obtained using an artificial intelligence (AI) model;
determining, based on the first quality metric and the second quality metric:
a first quality loss value representing a deviation of one or more of the first quality metric or the second quality metric from a reference quality metric associated with the media item, and
a second quality loss value representing a difference between the first quality metric and the second quality metric; and
providing the determined first quality loss value and the determined second quality loss value for retraining the AI model to predict improved quality metrics for additional media items.

14. The system of claim 13, wherein determining the first quality loss value comprises:
providing the one or more of the first quality metric or the second quality metric and the reference quality metric as an input to a mean squared error operation; and
obtaining one or more outputs of the mean squared error operation, the one or more outputs comprising the first quality loss value.

15. The system of claim 13, wherein determining the second quality loss value comprises:
providing the first quality metric and the second quality metric as an input to a hinge loss operation; and
obtaining one or more outputs of the hinge loss operation, the one or more outputs comprising the second quality loss value.

16. The system of claim 13, wherein the operations further comprise:
prior to providing the determined first quality loss value and the determined second quality loss value for retraining the AI model, providing the media item as an input to the AI model;
obtaining one or more outputs of the AI model, the one or more outputs comprising a quality metric predicted for the media item; and
designating the quality metric predicted for the media item as the reference quality metric associated with the media item.

17. The system of claim 13, wherein providing the determined first quality loss value and the determined second quality loss value for retraining the AI model comprises:
calculating a total training loss value associated with the AI model based on the determined first quality loss value and the determined second quality loss value; and
modifying one or more parameters associated with the AI model based on the calculated total training loss value.

18. The system of claim 17, wherein modifying the one or more parameters associated with the AI model based on the calculated total training loss value comprises:
performing one or more backpropagation operations using the total training loss value to obtain a gradient of total loss with respect to each of the one or more parameters associated with the AI model; and
updating at least one of the one or more parameters associated with the AI model based on the obtained gradient of total loss to obtain an updated AI model.

19. The system of claim 18, wherein the operations further comprise:
providing one or more additional variants of an additional media item as an input to the updated AI model;
obtaining one or more outputs of the updated AI model, the one or more outputs comprising predicted quality metrics for the one or more additional variants; and
determining an updated total training loss value based on the predicted quality metrics for the one or more additional variants.

20. A non-transitory computer-readable medium comprising instructions that, when executed by a processor, cause the processor to perform operations associated with identifying an emerging media trend of a platform, the operations comprising:
obtaining a first variant and a second variant of a media item;
identifying a first quality metric representing a first quality of the first variant and a second quality metric representing a second quality of the second variant, wherein the first quality metric and the second quality metric are obtained using an artificial intelligence (AI) model;
determining, based on the first quality metric and the second quality metric:
a first quality loss value representing a deviation of one or more of the first quality metric or the second quality metric from a reference quality metric associated with the media item, and
a second quality loss value representing a difference between the first quality metric and the second quality metric; and
providing the determined first quality loss value and the determined second quality loss value for retraining the AI model to predict improved quality metrics for additional media items.
